(19) United States
(12) Patent Application Publication
(10) Pub. No.: US 2002/0184558 A1
(43) Pub. Date: Dec. 5, 2002

(54) SUBSTRATE NOISE ISOLATION USING SELECTIVE BURIED DIFFUSIONS

(75) Inventor: D.C. Sessions, Phoenix, AZ (US)

Correspondence Address: Corporate Patent Counsel, Philips Electronics North America Corporation, 580 White Plains Road, Tarrytown, NY, 10591, US

(73) Assignee: Philips Semiconductor, Inc.

(21) Appl. No.: 09/871,407

(22) Filed: May 31, 2001

(51) Int. Cl. H04L 1/22

(52) U.S. Cl. 714/8

(57) ABSTRACT

A mixed-signal CMOS integrated semiconductor device exhibits reduced substrate noise coupling between digital and analog circuit functions using selectively formed isolated, high-impurity buried regions between substrate and epitaxial layers. The impedance within the high-impurity regions is relatively lower than the impedance between high-impurity regions, thereby reducing noise-induced potentials, and latchup, within high-impurity regions and noise-induced currents between high-impurity regions. An attenuation network is effectively formed in the semiconductor device layers to reduce noise coupling, the impedance within the high-impurity region acting as the pi attenuation network shunt path. High-impurity regions are formed by selectively diffusing or implanting impurities into bulk lightly-doped, silicon substrate layer prior to growing an epitaxial layer. The high-impurity regions, substrate and epitaxial layers are all of the same conductivity type.

### FIELD OF THE INVENTION

The present invention generally relates to integrated circuits, and more particularly, to methods and devices for reducing electrical noise coupling in integrated circuit chips.

### BACKGROUND OF THE INVENTION

Digital and analog circuits are conventionally combined on a single integrated circuit (“IC”) chip in order to achieve a number of advantages, such as lower cost, increased performance and further system miniaturization. In very large scale integration (“VLSI”) digital applications, signal delays due to parasitic resistance-capacitance loading in high fan-out global signals, such as synchronous clocks, become larger. Increasingly, analog phase locked loop (“PLL”) circuits are used to synchronize clock distribution signals. ICs comprising both digital and analog circuit components are commonly referred to as “mixed signal” ICs. A conventional implementation includes a common substrate upon which a multitude of interconnected digital and analog electrical circuits are fabricated.

One problem plaguing mixed-signal ICs is noise. Digital circuits are inherently electrically noisy, primarily attributable to the speed of switching digital components. Analog circuits are relatively quiet electrically. In mixed-signal applications, noise generated by the digital circuits is coupled into the analog circuits, causing errors in the sensitive, low-amplitude analog circuit.

Desirable technological IC chip improvements to increase digital circuit density and operating speed, have magnified mixed-signal noise problems. Increasing digital component densities increases the quantity of digital devices for a given area, and is accompanied by a corresponding increase in noise generation produced by the increased quantity of noise generation sources. Because the industry continues to find ways to reduce digital circuit geometries in VLSI chips, an inordinate number of digital circuits often switch simultaneously. This switching often results in intolerable noise levels.

Adequately overcoming these noise problems in the higher component VLSI chips is difficult. One reason is that, with the reduced digital circuit geometries, component dielectric margins are reduced. Also, efforts to implement digital circuit geometry reductions are typically in conjunction with efforts to reduce power supply voltage levels; however lowering power supply voltage levels limits the signal swing and this decreases the theoretical signal-to-noise ratio upper limit. When combined with the increasing noise generated by the denser digital logic, a decreasing theoretical limit of signal-to-noise ratio further strains analog circuit design.

Increased operating speeds can also contribute to greater electrical noise generation. Higher frequencies mandate faster and faster switching between digital states, accompanied by even sharper, higher-magnitude noise spiking. The faster switching rates increase the rate of change of the current, di/dt.

The adverse circuit effects due to noise generated by digital circuit elements, and coupled via a common IC substrate to analog circuit elements, is well known. These effects have been addressed with limited effectiveness using various mitigating corrective techniques; such techniques include providing an increased physical separation distance between digital and analog circuit regions, providing separate digital and analog ground conductors, modifying packaging input/output connections, improving IC package bonding methods, and increasing substrate impedance to reduce noise current flow.

Accordingly, a need exists to further reduce the substrate noise coupling between analog and digital circuit regions. A further need exists to preferably reduce noise currents through the substrate without generating high potentials across the substrate.

### SUMMARY OF THE INVENTION

The present invention is directed to overcoming the above-mentioned challenges and others related to mixed-signal circuits in semiconductor devices, such as the devices discussed above. The present invention is exemplified in a number of implementations and applications, some of which are summarized below.

One aspect of the present invention is directed to a semiconductor device including an improved mixed-signal integrated circuit that is less susceptible to erroneous operation due to noise generated within the integrated circuit. The integrated circuit includes a substrate layer of semiconductor material of a first conductivity type, an epitaxial layer of semiconductor material of a first conductivity type overlying the substrate layer, and a plurality of high-impurity regions of a first conductivity type. The high-impurity regions are disposed between the bulk semiconductor substrate layer and the semiconductor epitaxial layer, the high-impedance regions being isolated from one another. Interconnected digital circuit devices are formed in the semiconductor epitaxial layer, and interconnected circuit devices are adapted to generate analog functions formed in the epitaxial layer, wherein the low-impurity regions provide an impedance between high-impurity regions that is relatively larger than an impedance within the high-impurity regions.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a representation of silicon material impedance coupling between regions of an integrated circuit;

FIG. 2A is a side view of high-impurity regions buried between substrate and epitaxial layers, with superimposed schematic representation of coupling impedances, in accordance with the present invention;

FIG. 2B is a schematic representation of the substrate noise coupling impedances of a mixed-signal integrated circuit;

FIG. 3A is a side view of masked substrate layer in accordance with the present invention;

FIG. 3B. is a side view of diffused/implanted high-impurity regions into the substrate layer of FIG. 3A in accordance with the present invention;

FIG. 3C is a side view of buried high-impurity regions disposed between substrate and overlaying epitaxial layers in accordance with the present invention;

FIG. 3D is a side view of one embodiment of a CMOS integrated circuit having P-substrate/epitaxial layers and P+ buried regions in accordance with the present invention; and

FIG. 4 is a side view of one embodiment of a CMOS integrated circuit having N-substrate/epitaxial layers and N+ buried regions in accordance with the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to integrated circuit devices (“ICs”) wherein the semiconductor material (e.g., substrate and epitaxial layers) can be a common link between analog and digital devices, and a noise contributor. The present invention is believed to be particularly advantageous where analog and digital devices are coupled by the impedance of the semiconductor material. Noise is primarily produced by the switching of digital circuit devices typically localized in digital regions of an IC, which is communicated to analog circuit regions through semiconductor impedance. Coupled noise can be subsequently magnified by certain types of analog circuits, such as signal amplifiers. While the present invention is not necessarily limited to such devices, various aspects of the invention may be appreciated through a discussion of various examples using this context.

Noise currents flow through the common semiconductor impedance. One conventional method to reduce substrate noise coupling attempts to increase semiconductor impedance to reduce substrate noise current magnitude. Increased semiconductor impedance is achievable by forming the IC substrate from high-resistivity bulk silicon, or alternatively, forming a low-resistivity bulk silicon substrate along with a high-resistivity epitaxial layer have both been conventionally used to increase common semiconductor impedance. High impedance substrate/epitaxial layers, while forcing more noise currents into the relatively lower-resistance IC metallic conductors, also create higher potentials induced across the high impedance semiconductor material and can result in increased latchup problems. Lower semiconductor impedance reduce the induced potentials (and thus, latchup effects), but allow more noise current to pass through the semiconductor material and increase coupled noise problems.

A desirable solution includes “islands” of conductivity, separated by “moats” of resistance. Digital circuit devices within certain IC “islands” could be isolated from analog function circuit devices in other “islands.” The “islands” of conductivity reduced localized induced potentials to mitigate latchup problems within the “island” regions. The “moats” of resistance reduce the magnitude of noise currents flowing between IC regions (“islands”), such as between digital and analog IC regions. “Islands” of conductivity separated by “moats” of resistance in an IC are achieved by the present invention by creating regions of high-impurity, isolated within higher-resistance semiconductor material.

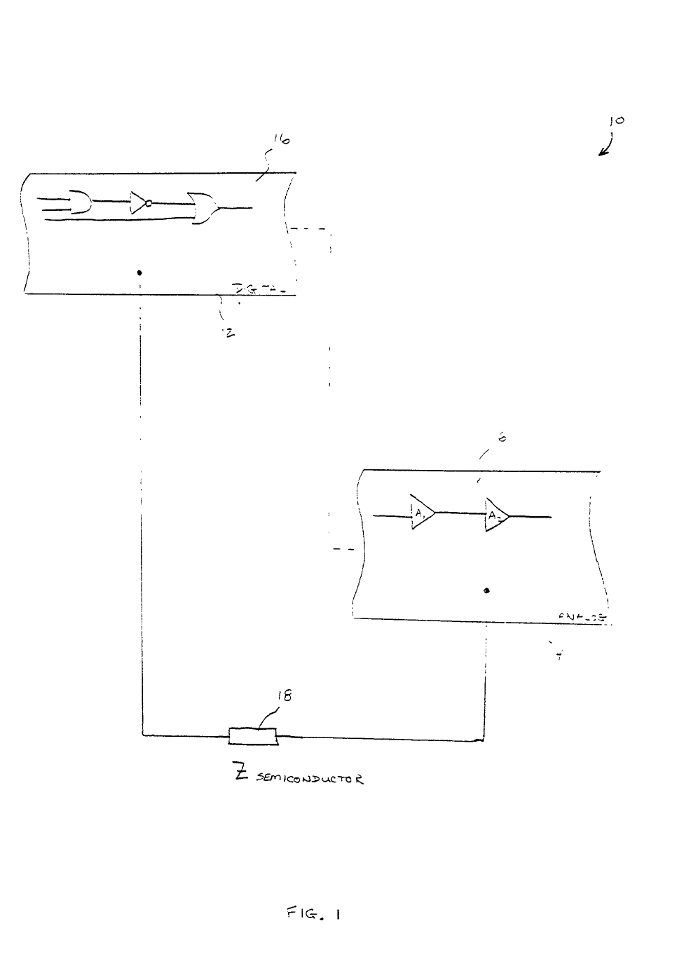

FIG. 1 illustrates a representation of a mixed-signal IC, generally indicated at 10. IC 10 is comprised of a digital region 12 and an analog region 14 formed within a common piece of semiconductor material 16. Semiconductor material impedance 18 couples digital region 12 and analog region 14.

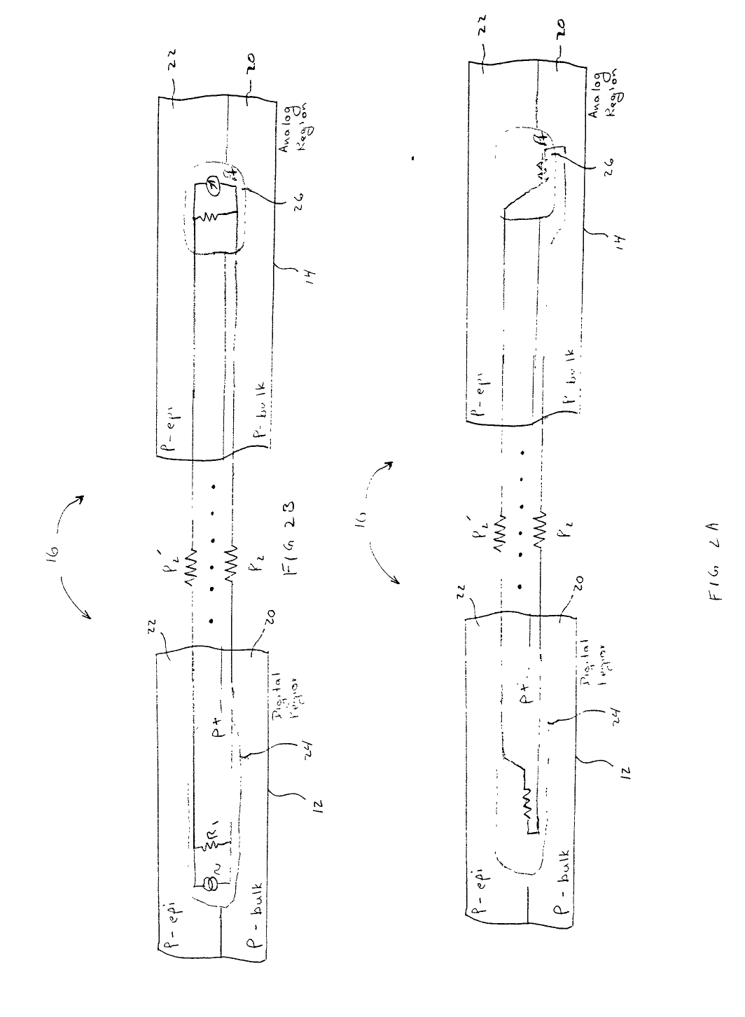

FIG. 2A illustrates one embodiment of the present invention and shows a side view of semiconductor material 16, prior to the formation of IC circuit devices. Although shown physically “split” into two independent regions for clarity, semiconductor material 16 is a single, common semiconductor wafer. A plurality of isolated regions are contemplated within semiconductor material 16. In the exemplary embodiment of FIG. 2A, digital region 12 and analog region 14 are shown. Semiconductor material 16 is comprised of a substrate layer 20 and an epitaxial layer 22 formed of the same conductivity type. Disposed between substrate layer 20 and epitaxial layer 22 are regions of high-impurity, having the same conductivity type as substrate layer 20 and epitaxial layer 22. A plurality of high-impurity regions are contemplated. FIG. 2A illustrates two such regions, first high-impurity region 24 and second high-impurity region 26. In the embodiment of FIG. 2A, substrate layer 20 is formed of P-bulk silicon, as is epitaxial layer 22. First and second high-impurity regions, 24 and 26 respectively, are formed to be P+. Alternatively, substrate layer 20 and epitaxial layer 22 are P doped. In a further embodiment, first and second high-impurity regions, 24 and 26, are P doped.

First high-impurity region has an internal impedance RI, illustrated schematically-superimposed on FIG. 2A. Similarly, second high-impurity region has an internal impedance R3. Semiconductor impedance couples first high-impurity region to second high-impurity region. Semiconductor impedance is illustrated schematically-superimposed on FIG. 2A as comprising substrate resistance R2 and epitaxial resistance R2′. For simplicity, R2 is assumed to be equivalent to R2′ since substrate layer and epitaxial layer are formed of the same conductivity type.

FIG. 2B is a schematic diagram representation of a noise coupling between digital region and analog region of FIG. 2A. Current source i represents noise currents generated in digital region. Voltage v represents a potential induced as a result of noise current i within analog region. In the embodiment illustrated in FIG. 2A, digital region is the aggressor as the source of noise, and analog region is the victim as the region susceptible to noise. Induced voltage v is determined from the following relationships:

v=i R3(R1//(2R2+R3))/(2R2+R3)

v=i (R1 R3(2R2+R3)/(2R2+R3)(R1+R3+2R2))

v=iR1 R3/(R1+R3+2R2)

Voltage v is minimized by maximizing R2 and/or by minimizing R1 and R3. Referring once again to FIG. 2A, induced voltage v is minimized by maximizing substrate impedance R2 and epitaxial impedance R2′. Induced voltage v is also minimized by minimizing first high-impurity region impedance R1 and second high-impurity impedance R3. In other words, creating “islands” of conductivity (minimized resistance), isolated by “moats” of (high) resistance.

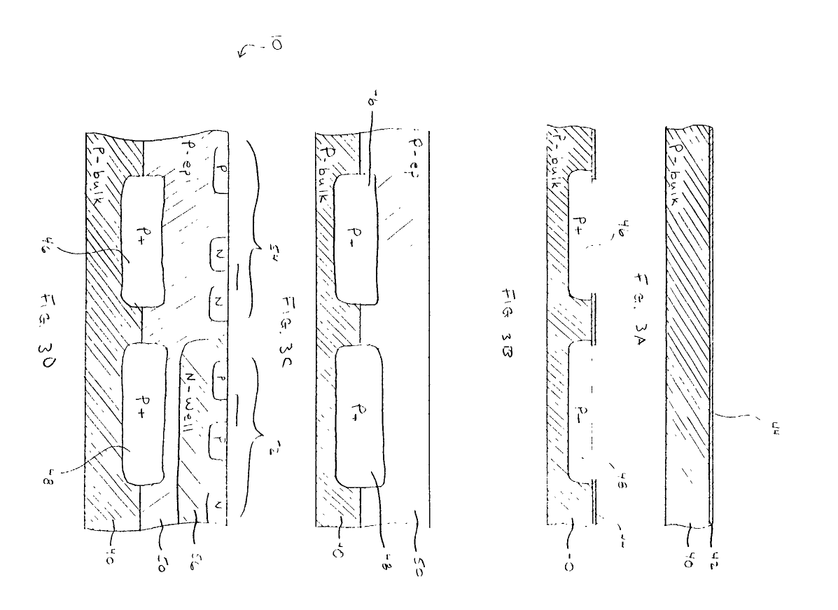

FIGS. 3A-3B illustrate one example of the invention as applied to the manufacture of a CMOS IC of the present invention. The first step is to prepare a P-type bulk silicon substrate layer 40 of a predetermined thickness as shown in FIG. 3A. Silicon substrate 40 is coated over its upper surface 42 with a mask layer 44, such as silicon dioxide film. Preselected areas of mask layer 44 are removed using conventional masking techniques. A P-type impurity is diffused to a high concentration into the portion of the substrate layer which is not covered by the mask layer, thus forming a first P+ high-impurity region 46 and second P+ high-impurity region 48 in FIG. 3B. Alternatively, high-impurity regions 46 and 48 are formed by implantation of impurities by conventional methods.

Mask layer 44 is then removed completely and a P-type epitaxial layer 50 is formed overlying silicon substrate layer 40 (having high-impurity regions) according to conventional techniques. During the process of forming epitaxial layer 50, the P-type impurity diffuses into epitaxial layer 50, expanding first 46 and second 48 high-impurity regions therein as illustrated in FIG. 3C.

Conventional methods are thereafter used to form digital circuit devices and circuit devices adapted to generate analog functions in epitaxial layer as illustrated in FIG. 3D. Both n- and p-channel transistors are fabricated into epitaxial layer 50 as shown in FIG. 3D for example, a CMOS N-channel FET device 52 and a CMOS P-channel FET device 54. N-channel devices are formed, for example, by first diffusing a well of N-type impurity 56 into P-type epitaxial layer 50 according to conventional methods.

FIG. 3D is vastly simplified to show high-impurity regions 46 and 48 in registration with only a single digital circuit device. It is contemplated that high-impurity regions are sized to underlie a plurality of circuit devices. While registration of high-impurity regions directly below specific circuit devices is illustrated, registration between circuit devices and high-impurity regions is not critical to achieving reduced semiconductor material noise coupling. However, registration may be desirable depending on IC circuit design. Registration of high-impurity regions (relatively high conductance “islands”) with certain digital circuit devices reduces induced potentials in the vicinity of the high-impurity regions, mitigating latchup effects of the associated with digital circuit elements. Therefore, certain advantages are realized by segregating particular circuit devices into specific IC areas and in registration with a high-impurity area.

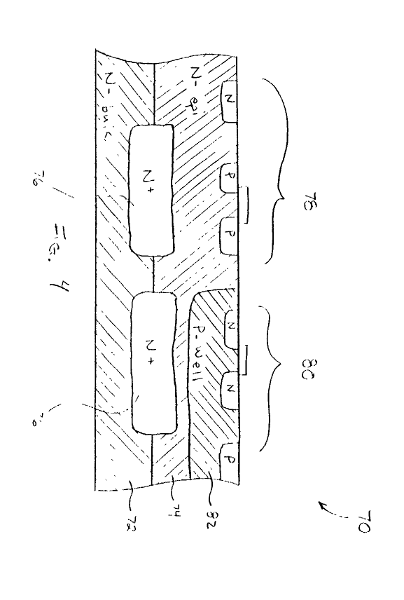

FIG. 4 illustrates another embodiment of an IC of the present invention, generally illustrated at 70. IC 70 is fabricated upon an N-type bulk silicon substrate layer 72 with an overlying N-type epitaxial layer 74 and buried high-impurity N+ type regions 76 disposed between substrate layer 72 and epitaxial layer 74. N-channel CMOS circuit devices 78 are formed directly into epitaxial layer 74, and p-channel CMOS circuit devices 80 are formed within a P-well 82 diffused within epitaxial layer 74. Alternatively, substrate layer 72 and epitaxial layer 74 are N doped. In a further embodiment, high-impurity regions 76 are N doped.

The present invention is achieved by diffusing or implanting selective high-impurity regions of one conductivity into lightly-doped bulk silicon substrate of the same conductivity prior to forming an epitaxial layer of the same conductivity as the substrate. This maintains high inter-regional isolation impedances while producing low intra-regional impedances. The resulting structure has superior latchup resistance and is applicable to mixed-signal CMOS ICs, especially those requiring PLL cells.

Accordingly, the present invention is not to be necessarily limited to the particular examples described above, but is intended to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. A method of making a mixed-signal integrated circuit less susceptible to erroneous operation due to noise generated within the integrated circuit, comprising:
forming first and second high-impurity regions of a first conductivity type into a substrate layer of semiconductor material of the first conductivity type, the first and second high-impurity regions isolated from one another;
forming at least one superimposed layer of semiconductor material of the first conductivity type overlying the substrate layer, the first and second high-impurity regions;
fabricating a plurality of interconnected digital circuit devices in the at least one superimposed layer; and
fabricating a plurality of interconnected circuit devices adapted to generate analog functions in the at least one superimposed layer, the first and second high-impurity regions configured and arranged to provide high conductivity within each high-impurity region and high impedance between the first and second high-impurity regions whereby substrate layer noise coupling between the plurality of interconnected digital circuit devices and the plurality of interconnected circuit devices adapted to generate analog functions is reduced.

2. The method of claim 1, wherein the plurality of interconnected digital devices are fabricated in a portion of the at least one superimposed layer of that overlies the first, but not the second, high-impurity region.

3. The method of claim 2, wherein the plurality of interconnected circuit devices adapted to generate analog functions are fabricated in a portion of the at least one superimposed layer that overlies the second, but not the first, high-impurity region.

4. The method of claim 1, wherein the first conductivity type is P type and the first and second high-impurity regions are P+ type.

5. The method of claim 1, wherein the first conductivity type is N type and the first and second high-impurity regions are N+ type.

6. The method of claim 1, wherein the first conductivity type is P− type and the first and second high-impurity regions are P+ type.

7. The method of claim 1, wherein the first conductivity type is N− type and the first and second high-impurity regions are N+ type.

8. The method of claim 1, wherein the at least one superimposed layer of semiconductor material of the first conductivity type is formed by epitaxial growth.

9. The method of claim 1, wherein the digital circuit devices and the circuit devices adapted to generate analog functions are CMOS devices.

10. The method of claim 1, wherein the first and second high-impurity regions are diffused into the substrate layer.

11. The method of claim 1, wherein the first and second high-impurity regions are implanted into the substrate layer.

12. The method of claim 1, further comprising forming a regions of a second conductivity type into the at least one superimposed layer of semiconductor material of the first conductivity type, wherein a portion of the plurality of interconnected digital circuit devices and a portion of the interconnected circuit devices adapted to generate analog functions are fabricated in the regions of the second conductivity type.

13. An improved mixed-signal integrated circuit less susceptible to erroneous operation due to noise generated within the integrated circuit, comprising:
a substrate layer of semiconductor material of a first conductivity type;
an epitaxial layer of semiconductor material of a first conductivity type overlying the substrate layer;
a plurality of high-impurity regions of a first conductivity type, the high-impurity regions disposed between the bulk semiconductor substrate layer and the semiconductor epitaxial layer, the high-impedance regions isolated from one another;
a plurality of interconnected digital circuit devices formed in the semiconductor epitaxial layer; and
a plurality of interconnected circuit devices adapted to generate analog functions formed in the epitaxial layer, wherein the high-impurity regions are arranged and configured to provide an impedance between high-impurity regions that is relatively larger than an impedance within the high-impurity regions.

14. The integrated circuit of claim 13, wherein the high-impurity regions are arranged and configured to provide a pi attenuation network within the substrate and epitaxial layers, the impedance within the high-impurity regions being a shunt portion and the impedance between high-impurity regions being a coupling portion of the pi attenuation network.

15. The integrated circuit of claim 14, wherein the pi attenuation network reduces noise coupling between the plurality of interconnected digital circuit devices and the plurality of interconnected circuit devices adapted to generate analog functions.

16. The integrated circuit chip of claim 13, wherein the high-impurity regions are diffused into the substrate layer.

17. The integrated circuit chip of claim 13, wherein the high-impurity regions are implanted into the substrate layer.
